(19) United States
(12) Patent Application Publication
(10) Pub. No.: US 2017/0006668 A1
(43) Pub. Date: Jan. 5, 2017

(54) COOKING APPLIANCE

(71) Applicant: Pinnacle Stoneworks LLC, Denver, CO (US)

(72) Inventor: Sergey Nikolenko, Denver, CO (US)

(21) Appl. No.: 14/755,697

(22) Filed: Jun. 30, 2015

(51) Int. Cl. H05B 6/12; H05B 6/36; H05B 6/06

(52) U.S. Cl. CPC H05B 6/1209; H05B 6/062; H05B 6/36

(57) ABSTRACT

A cooking appliance has a base made of natural stone, ceramic, porcelain, or an ultra-compact surface, with a bottom surface, and a top surface. The cooking appliance has an induction heating element coupled to the bottom surface. The induction heating element heats a targeted object placed on the top surface to a cooking temperature of at least 100 degrees Celsius.

### BACKGROUND

Field

The present invention relates generally to kitchen appliances, and more specifically to cooking appliances.

Background

Appliance manufacturers have provided for many years a variety of cooking appliances for heating food to a temperature of 100 degrees Celsius or more. In some cases, the cooking surfaces are generally planar.

However, there remains a need in the industry for a cooking and counter surface that is easy to clean and reduces the possibility of spilling food when moving pots or pans between the cooking surface and the counter surface, while also providing safety features such as a cool cook surface and a clean aesthetic appeal.

Induction heating is a process in which a targeted object having a ferrous material, such as a specially-designed pot, is heated using a magnetic field. The magnetic field is generally generated by induction coils on a bottom side of a non-conductive surface and passed through the surface, to the targeted object. Any heating of the surface is caused by the hot pot or pan, and not the induction coils.

Induction cooking is known in the industry, and has been available for years, with substantially flat cooking regions made of ceramic glass. However, for consumers using an aesthetically-pleasing countertop like granite or marble, all currently-available induction cooking surfaces require a first ceramic glass surface for use as a cooking surface and a second granite or marble surface for a countertop surface, resulting in an aesthetically displeasing seam between the cooking surface and the counter surface, that also causes a build-up of debris and germs. Consumers and commercial users must use harsh chemicals to reduce the build-up.

Induction warming, that is, heating to a temperature of 85 degrees Celsius or less, of food placed on natural stone surfaces such as granite is also available; however, natural stone surfaces such as marble or granite, porcelain, ceramic, and ultra-compact surfaces are not currently available for use as a cooking surface.

There therefore remains a need for a cooking appliance to bring food to a temperature of at least 100 degrees Celsius that provides a clean and safe surface while remaining aesthetically pleasing.

### SUMMARY

In some embodiments, a cooking appliance is provided that overcomes at least some of the needs herein described, as well as other new and innovative features.

In some aspects, a cooking appliance is provided. The cooking appliance has at least one induction heating element and a base. The base has a material selected from the group consisting of granite, marble, porcelain, ceramic, and an ultra-compact surface. The base also has a top surface, a cooking region, and a bottom surface. The at least one induction heating element is coupled to the bottom surface below the cooking region. The cooking region has a thickness between the top surface and the bottom surface of between 2 millimeters and 12 millimeters. The at least one induction heating element is configured to heat a targeted object placed on the cooking region to a temperature of at least 100 degrees Celsius.

In some aspects, a method of making a cooking appliance is provided. The method includes providing a base having a top surface, and a bottom surface, wherein providing a base comprises providing a base made of granite, marble, porcelain, ceramic, or an ultra-compact surface, and forming a cooking region having a thickness between the top surface and the bottom surface of between 2 millimeters and 12 millimeters. The method may include shaping the cooking region to receive at least one induction heating element below the cooking region. The method may include coupling at least one induction heating element to the bottom surface of the cooking region of the base, the at least one induction heating element configured to heat a targeted object placed on the top surface to a temperature of at least 100 degrees Celsius.

In some aspects, the cooking appliance has a base made of natural stone, ceramic, porcelain, or an ultra-compact surface, with a bottom surface, and a top surface. The cooking appliance may have an induction heating element coupled to the bottom surface. The induction heating element is configured to heat a targeted object placed on the top surface to a cooking temperature of at least 100 degrees Celsius.

### BRIEF DESCRIPTION OF THE DRAWINGS

FIG. 1 is a front view of an exemplary cooking appliance installed in a kitchen;

FIG. 2 is a top view of the exemplary cooking appliance in FIG. 1;

FIG. 3 is a bottom view of the exemplary cooking appliance in FIG. 2;

FIG. 4 is a partial section view illustrating aspects of an exemplary cooking appliance;

FIG. 5 is another partial section view illustrating some aspects of an exemplary cooking appliance; and

FIG. 6 is a flowchart of a method.

### DETAILED DESCRIPTION

For the purposes of this document, all absolute descriptive terms such as measurements including dimensions, or features such as “flat”, “planar” are to be understood as meaning within a reasonable manufacturing tolerance accepted in the industry. As just one example, the measurement “4.5 millimeters” is to be understood as meaning 4.5 millimeters to a reasonable manufacturing tolerance.

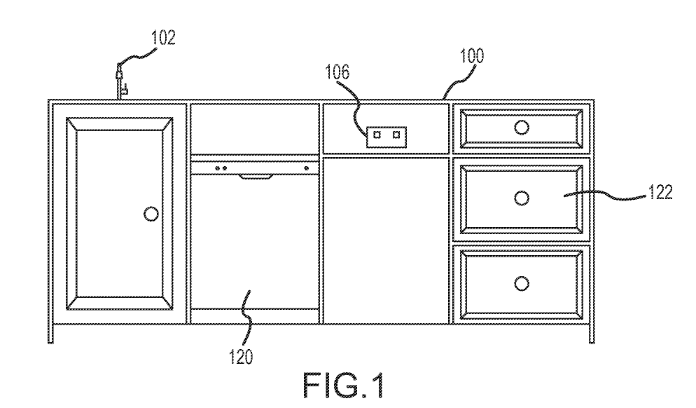

Referring now to the figures, where like references indicate similar or identical features, FIG. 1 illustrates a front view of a cooking appliance 100 according to some embodiments, installed with a sink 102 such as an undermount sink, a control panel 106 for controlling a cooking function of the cooking appliance 100, a dishwasher 120, and other kitchen appliances or cabinetry 122. The cooking appliance 100 may have an overall length L that may be much larger than a cooking region of the cooking appliance 100.

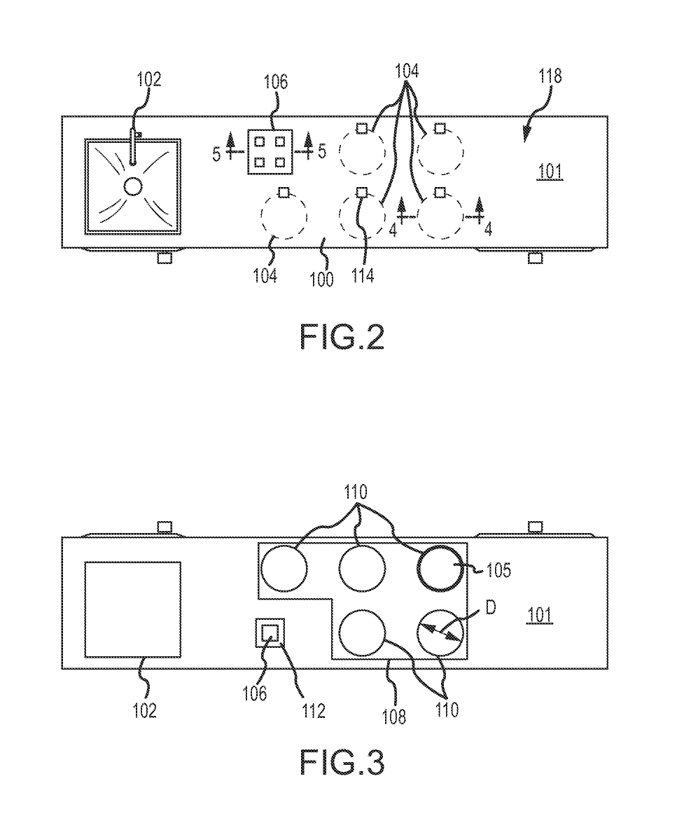

FIG. 2 illustrates a top view of aspects of an exemplary cooking appliance 100. The cooking appliance 100 has a base 101, and may provide a counter region 118 and one or more cooking regions 104; here, five cooking regions 104 are illustrated. The cooking regions 104 may be sized for standardized residential cooking pots and pans and/or commercial cooking pots and pans. The counter region 118, that is, regions that do not include a cooking region 104, should be at least as large as a pot or pan to be used with the cooking appliance 100.

Although the control panel 106 may be placed on a front surface of a cabinet as illustrated in FIG. 1, the control panel 106 may optionally be coupled to a top surface of the cooking appliance 100, as illustrated in FIGS. 2-3. The control panel 106 may include push button or other flat or nondescript features, and may be coupled flush to the base 101 of the cooking appliance 100, as illustrated in FIG. 5.

Continuing with FIG. 2, the cooking appliance 100 may have cooking region(s) 104 that are circular, square, or any desired shape to suit the user's needs; here, five circular cooking regions 104 having a first diameter d are illustrated, with cooking region indicators 114 painted on the surface to give a visual indication of where the cooking regions 104 are located.

With reference now to FIG. 3, the bottom surface of the cooking appliance 100 may have one or more passages for connecting the sink 102 and/or the control panel 106. If the cooking appliance 100 has a large thickness, such as is preferred by some consumers, recessed region(s) 108 may be provided for reducing the thickness of the cooking appliance 100 below the cooking region(s) 104 to enable the induction process to function correctly. That is, the induction heating element should be attached to the recessed region(s) 108 such that, in operation, a targeted object placed on top of the cooking region will heat to a cooking temperature. For example, a pot will heat to a temperature sufficient to cause water to boil, while a pan will heat to a temperature sufficient to sear a meat. The cooking temperature may be controllable using the control panel 106.

In some embodiments, the entire recessed region 108 is a cooking region 104 and/or the control panel 106 may detect a targeted object placed above the recessed region(s) 108 and cause only a respective region of one or more induction heating elements to heat the targeted object.

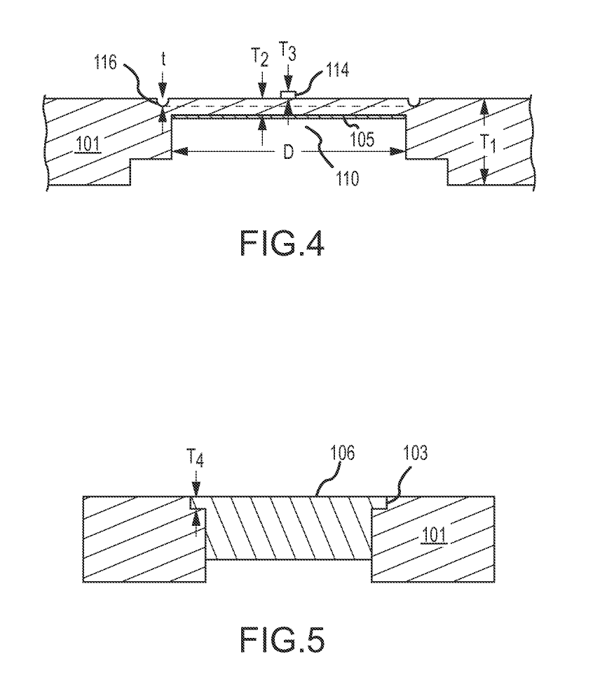

As illustrated in FIG. 4, the recessed region(s) 108 may include a recess that steps a cross section of the cooking appliance 100 from a first thickness T1 down to a second thickness T2. The first thickness T1 may be 3 cm or more. The second thickness may be between about 2 millimeters and about 12 millimeters. Those of skill in the art will understand that, for structural purposes, one or more steps between the first thickness T1 and the second thickness T2 may be provided, so as to avoid undesirable material stresses. It should also be understood that a curvature (not shown) between the steps may be provided to further avoid material stresses. Those skilled in the art will also understand that, depending on the type of material used, a second thickness T2 at the lower range may require a nonconductive brace 105 such as an aluminum brace as illustrated in FIG. 4 be installed to maintain the structural integrity of the base 101 while maximizing the operation of the induction cooking process.

That is, for example, when using a material such as quartz that limits the thickness T2 of the cooking region 104 to about 2-4 millimeters, an aluminum brace 105 may be placed on the underside of the base 101 to maintain the structural integrity of the cooking region 104 while still providing a functional cooking region 104.

Continuing with FIGS. 3 and 4, the portions of the recessed region(s) 108 having the second thickness T2 may be slightly greater than the cooking region(s) 104. That is, for circular cooking region(s) 104 having a first diameter d, the recessed region(s) 108 may have a second diameter D that is greater than the first diameter d, such as about 2-4 cm greater.

As previously described with reference to FIG. 2, a visual indicator such as a cooking region indicator 114 may be provided. In some embodiments, the cooking region indicator 114 is a painted-on visual indicator projecting a third thickness T3 from the top surface of the cooking appliance 100. The third thickness T3 may be very small, such as about 0.13 millimeters or less, so as to avoid detracting from the aesthetic appeal of the cooking appliance 100 and avoid causing a user who slides pots or pans across the cooking appliance 100 to spill food in the pots or pans.

In some embodiments, the cooking appliance 100 has a visual indicator such as a cooking region indicator 116 that may be a recess having a depth t etched or engraved into the cooking appliance 100. The cooking region indicator 116 may encircle the cooking region 104, as illustrated in FIG. 4.

Turning now to FIG. 5, in some embodiments, the base 101 has a flange surface 103 recessed to a depth T4, whereby the flange surface 103 seats the control panel 106 such that the control panel 106 is flush with the base 101.

With reference again to FIG. 4, the second thickness T2 is now described in further detail. The second thickness T2 is selected based on the type of material being used as a base 101 in combination with the ratings of the induction element (not shown) being used.

In the case of currently-available induction elements for use in kitchens, as of the time of preparation of this document, a quartz cooking appliance should have a second thickness T2 in the range of 2-4 millimeters. Granite and marble cooking appliances should have a second thickness in the range of about 6-12 millimeters. Ceramic, porcelain, and ultra-compact surfaces should have a second thickness in the range of about 4-7 millimeters, or about 4.0-5.0 millimeters, or about 4.5 millimeters. For the purpose of this document, the term “ceramic” is to be understood as excluding glass-ceramics. In natural stone cooking appliances, a second thickness T2 of about 4 millimeters is the minimum boundary for maintaining structural integrity of the natural stone without requiring a brace 105.

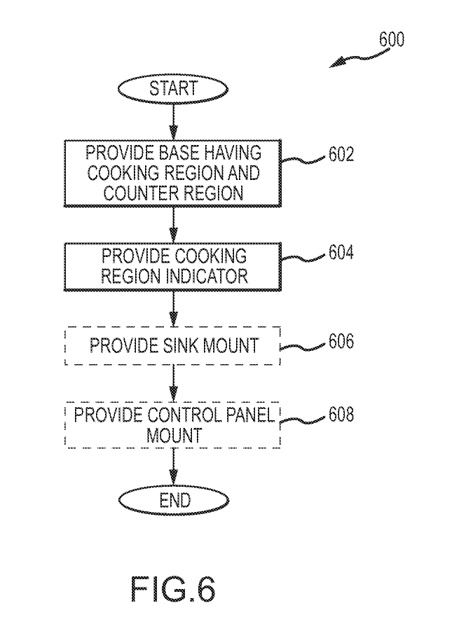

Turning now to FIG. 6, a method 600 of making a cooking appliance is now described. The method 600 includes providing 602 a base, and providing 604 a cooking region indicator. The method 600 may include providing 606 a sink mount and/or providing 608 a control panel mount.

Providing 602 a base includes providing a base having a cooking region and a counter region, as well as providing a blank slab of granite, marble, quartz, porcelain, ceramic, or ultra-compact surface, and machining a recessed region into a bottom surface of the blank slab. In some embodiments, the recessed region has a thickness of between about 2 millimeters and about 12 millimeters; however, those skilled in the art will understand that this thickness may change as the design of induction elements changes or improves. For example, where the strength of the induction field is increased, the thickness may be increased, or vice versa, so long as the structural integrity of the base is retained. The strength of the induction elements will be limited to ranges that do not interfere with medical devices. Providing 602 a base may be achieved using any base described with reference to FIGS. 1-5.

The method 600 also includes providing 604 a cooking region indicator on a top surface of the base, wherein the cooking region indicator does not protrude more than 0.13 millimeters above the top surface. Providing 604 a cooking region indicator may be achieved using any cooking region indicator 114, 116 described with reference to FIGS. 1-5.

Providing 606 a sink mount, which is optional in some embodiments, includes providing a mount shaped to receive an undermount sink.

Providing 608 a control panel mount, which is optional, includes providing a recessed flange surface in the base, such that the recess is deep enough to allow a control panel to sit flush with the top surface of the base. Providing 608 a control panel mount may be achieved by machining a flange surface 303 into the base 101 as illustrated in FIG. 5.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A cooking appliance, comprising:
at least one induction heating element;
a base having a top surface, an induction cooking region, and a bottom surface; wherein
the at least one induction heating element is positioned below the cooking region;
the cooking region is made of granite or marble, and has a thickness between the top surface and the bottom surface, the thickness being between 6 millimeters and 12 millimeters; and
the at least one induction heating element is configured to heat a targeted object placed on the cooking region to a temperature of at least 150 degrees Celsius.

2. (canceled)

3. The cooking appliance of claim 1, further comprising:
at least one passage through the base, the at least one passage shaped to receive an undermount sink.

4. The cooking appliance of claim 1, further comprising:
at least one passage through the base, the at least one passage having a recessed flange surface shaped to receive a cooktop control panel and seat the cooktop control panel flush with the top surface.

5. The cooking appliance of claim 1, wherein
the base comprises a counter region made of granite or marble; and
the induction cooking region is unitary with the counter region.

6. The cooking appliance of claim 1, further comprising:
a control panel, whereby the appliance is configured to detect a targeted object placed on the cooking region, and to cause only a respective region of the at least one or more induction heating element to heat the targeted object.

7. (canceled)

8. (canceled)

9. (canceled)

10. The cooking appliance of claim 1, wherein
the base is formed from a unitary slab of granite or marble;
the base has a plurality of induction cooking regions and a counter region unitary with the plurality of induction cooking regions; and wherein
the counter region has a surface area that is at least as much as a combined surface area of the plurality cooking regions.

11. A method of using a cooking appliance, the method comprising:
providing a cooking appliance, the appliance comprising: (a) at least one induction heating element, and (b) a base having a top surface, an induction cooking region, and a bottom surface, wherein the at least one induction heating element is positioned below the cooking region, the cooking region is made of granite or marble, and has a thickness between the top surface and the bottom surface, the thickness being between 6 millimeters and 12 millimeters, and the at least one induction heating element is configured to heat a targeted object placed on the cooking region to a temperature of at least 150 degrees Celsius; and
causing the at least one induction heating element to heat the targeted object placed on the cooking region to the temperature of at least 150 degrees Celsius.

12. The method of claim 11, wherein:
causing the at least one induction heating element to heat the targeted object without causing the appliance to break.

13. The method of claim 11, wherein:
the appliance comprises a control panel; and
the method comprises detecting a targeted object placed on the cooking region.

14. The method of claim 13, wherein:
the appliance comprises a plurality of induction heating elements; and
the method comprises, responsive to the detecting, causing only a respective region of a plurality of induction heating elements to heat the targeted object.

15-20. (canceled)
